(19) United States
(12) Patent Application Publication
(10) Pub. No.: US 2024/0258051 A1
(43) Pub. Date: Aug. 1, 2024

(54) TEMPERATURE-DEPENDENT SWITCH AND METHOD OF MANUFACTURING THE SAME

(71) Applicant: Marcel P. Hofsaess, Steintahleben (DE)

(72) Inventor: Marcel P. Hofsaess, Steintahleben (DE)

(21) Appl. No.: 18/425,338

(22) Filed: Jan. 29, 2024

(30) Foreign Application Priority Data
Jan. 31, 2023 (DE) 10 2023 102 301.2

(51) Int. Cl. H01H 37/54; H01H 37/52; H01H 37/72

(52) U.S. Cl. CPC H01H 37/54; H01H 37/72; H01H 2037/525; H01H 2037/5463

(57) ABSTRACT

A temperature-dependent switch having a first external terminal, a second external terminal and a temperature-dependent switching mechanism. The temperature-dependent switching mechanism comprises a temperature-dependent switching element which is configured to change its geometric shape as a function of its temperature in order to switch the switching mechanism between a closed position, in which the switching mechanism establishes an electrically conductive connection between the first external terminal and the second external terminal, and an open position, in which the switching mechanism disconnects the electrically conductive connection. The temperature-dependent switching mechanism comprises a spring element which is permanently electrically and mechanically connected in series to the temperature-dependent switching element. The temperature-dependent switching mechanism also comprises a connecting component, which is arranged between the spring element and the temperature-dependent switching element and is attached to the spring element and the temperature-dependent switching element.

### CROSS-REFERENCE TO RELATED APPLICATIONS

This application claims priority from German patent application DE 10 2023 102 301.2, filed on Jan. 31, 2023. The entire content of this priority application is incorporated herein by reference.

### FIELD

This disclosure relates to a temperature-dependent switch. The disclosure further relates to a method of manufacturing a temperature-dependent switch.

### BACKGROUND

An exemplary temperature-dependent switch is disclosed in DE 198 07 288 A1.

Such temperature-dependent switches are used in a known manner to monitor the temperature of a device. For this purpose, the switch is brought or rather via one of its outer surfaces into thermal contact with the device that is to be protected, for example, so that the temperature of the device that is to be protected influences the temperature of the switching mechanism that is arranged in the interior of the switch.

The switch is electrically connected in series in the supply circuit of the device that is to be protected by means of its external electrical connections via connecting lines, so that below a response temperature of the switch the supply current of the device that is to be protected flows through the switch.

A temperature-dependent switching mechanism that is installed in the switch ensures a temperature-dependent switching behaviour of the switch. This temperature-dependent switching mechanism is typically arranged between two electrodes, each of which is electrically connected to one of the two external terminals. The temperature-dependent switching mechanism is designed such that below the response temperature of the switch or the response temperature of the switching mechanism it is in a closed position, in which the switching mechanism establishes an electrically conductive connection between the two electrical external terminals of the switch, and when the response temperature of the switch is exceeded the temperature-dependent switching mechanism changes to an open position, in which the electrically conductive connection between the two electrical external terminals of the switch is disconnected or interrupted.

In this way, the temperature-dependent switching mechanism ensures that in its closed position, in which it is located below the response temperature of the switch, it closes the supply circuit of the device that is to be protected and in its open position, in which it is located above the response temperature of the switch, it interrupts the supply circuit of the device that is to be protected. A temperature-dependent switch of this type can therefore be used to ensure that an electrical device is automatically de-energised by the switch in the event of unwanted overheating and thus switched off.

Such temperature-dependent switches thus offer protection against overtemperature in electrical devices of all kinds.

A temperature-dependent switching element, which is configured to change its geometric shape as a function of its temperature, is responsible in particular for the temperature-dependent switching behaviour of the switching mechanism of the switch. When the response temperature of the switch is achieved and/or exceeded, this temperature-dependent switching element changes its geometric shape in such a way that it moves the switching mechanism from its closed position to its open position. Typically, this temperature-dependent switching element is a bimetallic or trimetallic element that is designed as a multi-layer, active, sheet metal component that consists of two, three or more interconnected components with different thermal expansion coefficients. The connection of the individual layers of metals or metal alloys in such bimetallic or trimetallic elements is usually in a firmly bonded or positive-locking manner and is achieved, for example, by rolling.

A bimetallic or trimetallic switching element of this type comprises a first stable geometric configuration (low temperature configuration) at low temperatures, below the response temperature of the switch, which corresponds to the response temperature of this switching element, and a second stable geometric configuration (high temperature configuration) at high temperatures, above the response temperature of the bimetallic or trimetallic switching element. The temperature-dependent switching element thus switches from its low-temperature configuration to its high-temperature configuration depending on the temperature in the manner of a hysteresis.

If the temperature of the temperature-dependent switching element rises above the response temperature of the switching element as a result of an increase in the temperature of the device that is to be protected, the switching element snaps from its low-temperature configuration to its high-temperature configuration and thus moves the switching mechanism from its closed position to its open position, which interrupts the current flow through the switch. If the temperature of the switch and thus also of the temperature-dependent switching element subsequently drops below a so-called response temperature of the switching element as a result of the device that is to be protected cooling down, the switching element changes its geometric shape again from its high-temperature configuration to its low-temperature configuration, so that the switching mechanism is brought back into its closed position, allowing current to flow through the switch again.

Typically, such temperature-dependent switching elements made of bimetal or trimetal are designed in such a way that their above-mentioned response temperature is lower than their response temperature. In principle, however, the temperature-dependent switching element can also be designed so that its response temperature is in the same temperature range or even at exactly the same temperature as its response temperature.

In addition to the temperature-dependent switching element, an additional spring element is often also used in switching mechanisms of such temperature-dependent switches and in the closed position the additional spring element generates or at least helps to generate the mechanical closing pressure of the switching mechanism. The spring element is a temperature-independent spring element, which is preferably made of metal. This spring element relieves the switching element, particularly in the closed position of the switching mechanism, since the switching element then has to apply less force or no force at all in order to generate the mechanical closing pressure in the closed position of the switching mechanism.

Temperature-dependent switches whose switching mechanisms have a temperature-independent spring element in addition to the temperature-dependent switching element can be categorised into two functionally different alternatives with regard to the configuration, arrangement and type of interaction of the switching and spring elements.

According to a first alternative, the spring element is electrically and mechanically connected in parallel to the temperature-dependent switching element in the switch. A switch with such a design of the switching mechanism is disclosed, for example, in DE 197 48 589 A1.

In this design of the switching mechanism, the spring element and the temperature-dependent switching element are usually disc-shaped and are coupled to each other via a movable contact part. The spring element is designed as a spring disc, which is attached at the centre to the movable contact part. The temperature-dependent switching element is usually designed as a bimetallic snap disc, which is placed with a central opening over the movable contact part. In the closed position of the switching mechanism, the spring disc presses the movable contact part against a stationary mating contact, which is arranged on a first electrode of the switch or forms a first electrode of the switch and is electrically connected to an external terminal of the switch, and rests with its outer edge on a second electrode of the switch, which is electrically connected to a second external terminal of the switch. In this way, in the closed position of the switching mechanism the electrical current flows between the two electrodes via the spring disc, which also simultaneously generates the contact pressure with which the movable contact part is pressed against the stationary contact part. The bimetallic snap disc can be mounted mechanically force-free in the closed position of the switching mechanism and is preferably not current-carrying, which has a positive effect on its service life.

According to a second alternative, the spring element is not connected electrically and mechanically in parallel to the temperature-dependent switching element in the switching mechanism, but in series. A switch with such a construction of the switching mechanism is disclosed, for example, in DE 198 07 288 A1 that is mentioned at the beginning. The switch is also a switch with such a switching mechanism in series connection.

In this design of the switching mechanism, the spring element is typically designed as an elongated spring tongue made of metal and the temperature-dependent switching element is designed as an elongated spring tongue made of bimetal or trimetal. One end of the spring element is attached to a first electrode that is electrically connected to the first external terminal of the switch. An opposite second end of the spring element is firmly connected to the temperature-dependent switching element. The free end of the temperature-dependent switching element, which is opposite the end of the switching element that is attached to the spring element, comprises a movable contact part. This movable contact part interacts with a stationary contact part, which is arranged on a second electrode of the switch that is electrically connected to the second external terminal.

In this second alternative of the switching mechanism, the movable contact part is pressed against the stationary contact part by both the spring element and the temperature-dependent switching element in the closed position of the switching mechanism. The spring element and the temperature-dependent switching element therefore jointly generate the closing pressure in the closed position of the switching mechanism due to their series connection and their attachment to each other.

Since, as mentioned, they are not only mechanically but also electrically connected in series according to this switching mechanism design, the current flows in series through the spring element and the temperature-dependent switching element in the closed position of the switching mechanism. The switching element is more of a disadvantage compared to the above-mentioned parallel design of the switching mechanism, since the temperature-dependent switching element is therefore permanently energised in the closed position of the switch and is therefore subjected to greater stress.

However, this can also be advantageous for certain applications, since the series-connected design of the switching mechanism means that the temperature-dependent switching element heats up very quickly at high operating currents, so that such a switch reacts not only to overtemperature but also to overcurrent. In addition, the design with the spring element and switching element connected in series is significantly more cost-effective and simpler to realise than the parallel design, since the switching mechanism itself and the switching mechanism housing require significantly simpler and smaller components. The series design of the switching mechanism is therefore particularly suitable for cost-effective versions of temperature-dependent switches.

The following further point should be noted in the case of a switching mechanism in the pure design of the spring and switching element: if the temperature-dependent switching element is made of a bimetal or trimetal, the switching element, like all bimetal or trimetal elements, undergoes a so-called creep phase during the transition from the closed to the open position and in the so-called creep phase the switching element gradually deforms as a result of an increase in temperature, but without abruptly snapping from its low-temperature configuration to its high-temperature configuration. This creep phase occurs not only when the temperature of the bimetallic or trimetallic element approaches its response temperature from below, but also when it approaches its response temperature from above. In both cases, this leads to noticeable conformational changes. The creep behaviour of a bimetallic or trimetallic element can also change, particularly as a result of ageing or long-term operation.

During the opening movement, creeping can cause the force that the temperature-dependent switching element exerts on the stationary contact part to decrease. During the closing movement, the contact can gradually approach the stationary contact part during the closing phase, which can cause the risk of arcing. This creeping behaviour of the switching element is compensated for in the case of the switch known from DE 198 07 288 A1 by the spring element that is mechanically connected in series to the switching element. If the geometry of the switching element gradually changes during the creep phase, this is immediately compensated for by the spring element. The spring element therefore acts as a kind of compensating spring that compensates for this undesirable creep effect of the switching element.

Although the switch known from DE 198 07 288 A1 has proven to be advantageous at least for certain applications, for example protection against overcurrent, and the above-mentioned creep phase problem could be compensated for by the spring element, there is still room for improvement.

It has been found, for example, that attaching the temperature-dependent switching element to the spring element using the standard welding and soldering methods typically used for this often leads in practice to damage to these two components. Since both the spring element and the temperature-dependent switching element are usually designed as spring tongues made of very thin sheet metal, such soldered or welded joints must be created extremely carefully and with a high degree of sensitivity, which is usually only possible manually and can hardly be automated. Due to the fragile design of both components, the switching mechanism often also lacks mechanical stability, which leads to a comparatively low robustness of the switching mechanism against vibrations.

### SUMMARY

It is an object to provide a temperature-dependent switch having a switching mechanism according to the above-mentioned second alternative (series connection of spring element and switching element), which may overcome the above-mentioned disadvantages. In particular, a high functional reliability and a long service life may be achieved with an inexpensive and simple design.

According to a first aspect, a temperature-dependent switch is provided, which comprises a first external terminal, a second external terminal, and a temperature-dependent switching mechanism. The temperature-dependent switching mechanism comprises a temperature-dependent switching element which is configured to change its geometric shape as a function of its temperature in order to switch the switching mechanism between a closed position, in which the switching mechanism establishes an electrically conductive connection between the first external terminal and the second external terminal, and an open position, in which the switching mechanism disconnects the electrically conductive connection. The temperature-dependent switching mechanism also comprises a spring element that is permanently electrically and mechanically connected in series to the temperature-dependent switching element. In addition, the temperature-dependent switching mechanism comprises a connecting component that is arranged between the spring element and the temperature-dependent switching element and is attached to the spring element and the temperature-dependent switching element.

The spring element and the temperature-dependent switching element are permanently electrically and mechanically connected in series in a similar way to the switch disclosed in DE 198 07 288 A1. However, an extra connecting component is additionally provided, which is arranged between the spring element and the temperature-dependent switching element and is attached both to the temperature-dependent spring element and to the temperature-dependent switching element. This connecting component is preferably a dimensionally stable component, for example in the form of a metal sheet, which is attached to the spring element on the one hand and to the temperature-dependent switching element on the other.

The provision of such an extra connecting component between the spring element and the temperature-dependent switching element offers various advantages. Firstly, it simplifies the manufacture of the switching mechanism, since the spring element and the switching element do not have to be attached directly to each other, which in practice is particularly difficult since both elements are typically made of very thin and fragile sheet metal. The additional connecting component therefore also increases the stability of the mechanical connection between the spring element and the temperature-dependent switching element. This increases the overall stability of the switching mechanism. In addition, the electrical resistance of the switching mechanism can be individually adapted to the desired switching behaviour by selecting a suitable material for the connecting component.

A further advantage of the connecting component is that it provides additional height, so that the spring element and the temperature-dependent switching element do not have to bend too much in the closed position of the switching mechanism in order to generate sufficient closing pressure. The connecting component thus provides mechanical relief for the spring element and the temperature-dependent switching element in the closed position of the switching mechanism.

The connecting component can also be used as a carrier material that is integrally connected to the conveyor belt during automated manufacture of the switch. For example, the connecting component can be a metal sheet that is integrally connected to an endless conveyor belt during the automated manufacture of the switching mechanism and to which the spring element and the temperature-dependent switching element are then automatically attached. The sheet metal can then be punched out from the conveyor belt, making it simple to pre-manufacture the part of the switching mechanism that comprises the spring element, the connecting element and the switching element, which can then be stored as bulk material.

It would not be possible to attach the switching element directly to the spring element in the above-mentioned automated manner without such an extra connecting component, as neither the spring element nor the switching element is suitable as a carrier material for a conveyor belt due to their design as typically very thin metal sheets.

According to a second aspect, a method of manufacturing a temperature-dependent switch is provided, comprising the steps of: (i) providing a conveyor belt to which a plurality of connecting components made of sheet metal are integrally connected; (ii) attaching a spring element and a temperature-dependent switching element to one of the plurality of connecting components such that the spring element is electrically and mechanically connected in series to the temperature-dependent switching element; (iii) separating the one connecting component from the conveyor belt to form a switching mechanism assembly that comprises the one connecting component to which the spring element and the temperature-dependent switching element are attached; (iv) connecting the switching mechanism assembly to a first external terminal and a second external terminal to form a temperature-dependent switch with a temperature-dependent switching mechanism in which the temperature-dependent switching element is adapted to change its geometric shape in response to its temperature in order to switch the switching mechanism between a closed position in which the switching mechanism establishes an electrically conductive connection between the first external terminal and the second external terminal and an open position in which the switching mechanism disconnects the electrically conductive connection; and (v) repeating steps (ii)-(iv) for more of the plurality of connecting components.

In summary, the presented switch is simpler to manufacture and comprises a mechanically more stable switching mechanism as compared to the switch disclosed in DE 198 07 288 A1.

According to a refinement, the connecting component is essentially plate-shaped.

Preferably, the connecting component comprises a metal sheet that lies flat against the spring element on the one hand and flat against the switching element on the other. This enables a simple and mechanically stable connection between the spring element, the connecting component and the switching element and at the same time ensures good electrical contact between these three components.

According to a further refinement, a first side of the connecting component is attached to the spring element by means of a first firmly bonded connection and a second side of the connecting component is attached to the temperature-dependent switching element by means of a second firmly bonded connection.

Preferably, the two sides mentioned are opposite sides of the connecting component. The spring element is particularly preferably attached to the top of the connecting component and the switching element to the bottom of the connecting component. Both firmly bonded connections can be produced in the same way. For example, the firmly bonded connections between the spring element and the connecting component on the one hand and between the connecting component and the switching element on the other hand can each be a soldered or welded connection.

According to a further refinement, the connecting component is thicker than the spring element and the temperature-dependent switching element.

In other words, the connecting component is preferably thicker than the spring element and the temperature-dependent switching element. It therefore provides additional mechanical reinforcement, which increases the stability of the switching mechanism. Due to its greater material thickness, it is better suited as a carrier material that is integrally connected to a conveyor belt in the case of an automated manufacture of the switching mechanism as mentioned above.

The spring element and the connecting component are preferably each made of metal, particularly preferably sheet metal. The connecting component can be made of a different metal than the spring element. The temperature-dependent switching element is preferably made of a bimetal or trimetal.

According to a further refinement, the spring element and the temperature-dependent switching element are connected to each other only indirectly via the connecting component, but not directly. This has a positive effect on the freedom of movement of the spring element and the temperature-dependent switching element.

According to a further refinement, a first end of the spring element is attached to a first electrode of the switch and the first electrode is electrically connected to the first external terminal, wherein a second end of the spring element is attached to the connecting component.

This measure leads to a simple construction, wherein the spring element is preferably designed as an elongated spring tongue, which is attached to the first electrode with its first end in the manner of a cantilever beam and is thus firmly clamped and is attached to the connecting component with its free, second end.

According to a further refinement, a first end of the temperature-dependent switching element is attached to the connecting component and a second end of the temperature-dependent switching element carries a movable contact part which, in the closed position of the switching mechanism, is pressed against a stationary contact part by the spring element and the temperature-dependent switching element, the stationary contact part being arranged on a second electrode that is electrically connected to the second external terminal, and wherein the temperature-dependent switching element is configured to change its geometric shape as a function of its temperature in such a way that it lifts the movable contact part from the stationary contact part in the open position of the switching mechanism in order to disconnect the electrically conductive connection.

The spring element and the temperature-dependent switching element thus jointly generate the contact pressure in the closed position of the switching mechanism, with which the movable contact part is pressed against the stationary contact part. At the same time, the spring element acts as a kind of compensating spring, which compensates for unwanted creeping movements of the temperature-dependent switching element.

According to a further refinement, the first end of the spring element and the second end of the temperature-dependent switching element are on the same side of the connecting element in relation to the connecting element.

This results in a kind of V- or U-shaped arrangement of spring element, connecting component and switching element. This makes it possible to realise a low-height switching mechanism.

According to a further refinement, the first electrode and the second electrode are held at a distance from each other by an insulating material carrier, wherein the temperature-dependent switching mechanism is arranged in a recess in the insulating material carrier between the first and second electrodes.

On the one hand, the insulating material carrier therefore insulates the two electrodes electrically from each other and also acts as a mechanical structural component that supports both electrodes and on the other hand thus increases the stability of the switch structure. The insulating material carrier can also function as a housing or form part of it.

According to a further refinement, the first external terminal and the second external terminal are arranged parallel to each other in a common plane.

This significantly simplifies the electrical connectivity of the switch.

According to a further refinement, the first electrode is shaped like a cover or plate or disc and is surrounded along its entire circumference by the insulating material carrier.

The first electrode can therefore act as a cover for the switch, which is preferably hot-stamped with the insulating material carrier and sealed all around its entire circumference. This improves the mechanical sealing of the switch.

According to a further refinement, the wire connecting element is at least partially encased in or embedded in an insulating material.

For example, the wire connecting element can be embedded in the insulating material carrier. This means that it is shielded from the switching mechanism and electrically insulated. At the same time, the wire connecting element is housed in the switch to save space.

It is understood that the above-mentioned features and those to be explained below can be used not only in the combination indicated in each case, but also in other combinations or on their own, without departing from the spirit and scope of the present disclosure.

### BRIEF DESCRIPTION OF THE DRAWINGS

FIG. 1 shows a schematic sectional view of an exemplary embodiment of the switch, with the temperature-dependent switching mechanism in its closed position;

FIG. 2 shows a schematic sectional view of the exemplary embodiment of the switch shown in FIG. 1, with the switching mechanism in its open position;

FIG. 3 shows a schematic top view of the exemplary embodiment of the switch shown in FIG. 1; and

FIG. 4 shows a schematic view illustrating part of the method for the automated manufacture of the switch.

### DESCRIPTION OF PREFERRED EMBODIMENTS

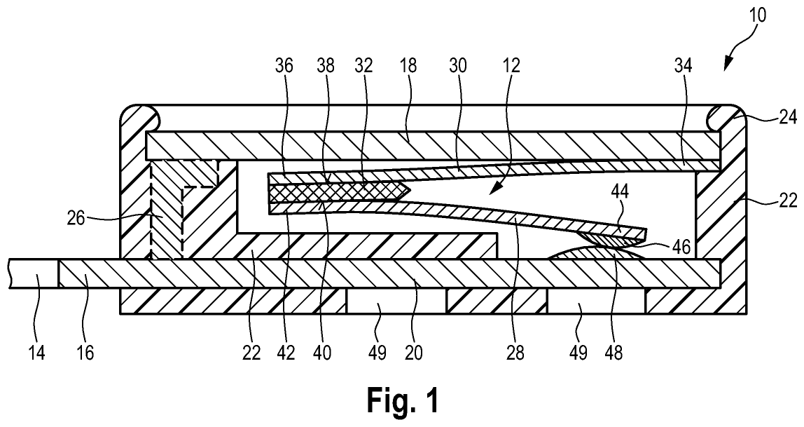

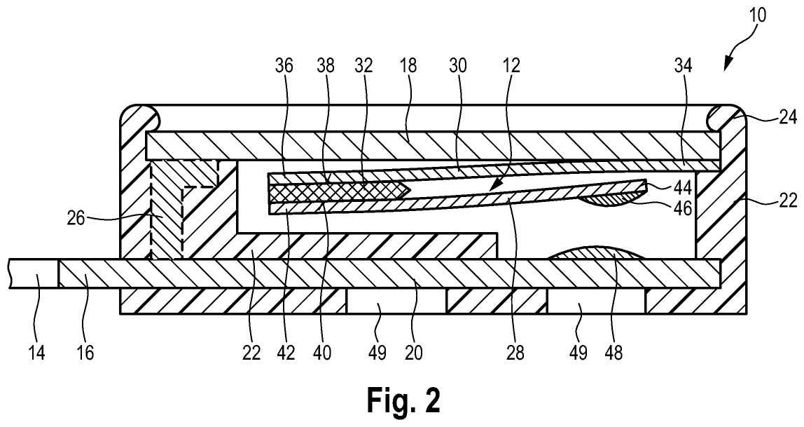

FIGS. 1 and 2 each shows a schematic sectional view of an exemplary embodiment of the temperature-dependent switch. The switch is labelled in its entirety with the reference number 10.

FIG. 1 shows the closed position of the switch 10. FIG. 2 shows the open position of the switch 10.

The switch 10 comprises a temperature-dependent switching mechanism 12, which is configured to switch the switch 10 from its closed position to its open position and vice versa as a function of its temperature.

In the closed position of the switch 10 shown in FIG. 1, the switching mechanism 12 establishes an electrically conductive connection between the two external terminals 14, 16 of the switch. In the open position of the switch 10 shown in FIG. 2, in contrast, the switching mechanism 12 disconnects the electrically conductive connection between the first external terminal 14 and the second external terminal 16.

The first external terminal 14 is conductively connected to a first electrode 18. This first electrode 18 also forms the cover of the switch 10. The second external terminal 16 is electrically conductively and preferably integrally connected to a second electrode 20, which is arranged parallel to and at a distance from the first electrode 18. Both electrodes 18, 20 are preferably designed as flat electrodes. The switching mechanism 12 is arranged inside the switch 10 in the space between the two electrodes 18, 20.

The two electrodes 18, 20 are held by an insulating material carrier 22. This insulating material carrier 22 is essentially pot-shaped and forms the lower housing part of the switch 10. The insulating material carrier 22 is formed around the second electrode 20 by overmoulding or casting in such a way that the second electrode 20 is an integral part of the lower housing part. The lower part of the housing is closed by the first electrode 18, which acts as a cover part. The first electrode 18 is surrounded all round, along its entire circumference, by the insulating material carrier 22 and is held captive by a hot-stamped upper edge 24 of the insulating material carrier 22.

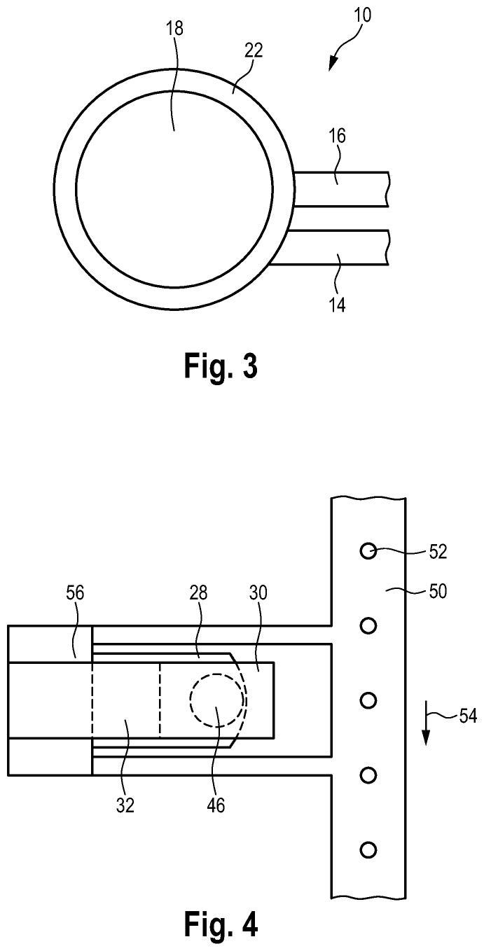

As shown in FIG. 3, the two external terminals 14, 16 are guided out of the insulating material carrier 22 parallel to one another. A wire connecting element 26, which is arranged inside the insulating material carrier 22, runs transversely, preferably orthogonally, to the two electrodes 18, 20.

This wire connecting element 26 connects the first electrode 18 to the first external terminal 14. In this way, it is possible to arrange the two external terminals 14, 16 in a common plane despite the vertically offset arrangement of the two electrodes 18, 20. By the arrangement in a common plane is meant that the two external terminals 14, 16 are designed as flat or plate-shaped connections, wherein their respective upper sides are arranged in a first common plane and their respective lower sides are arranged in a common second plane, which runs parallel to the first plane. Such an arrangement of the two external terminals in a common plane simplifies the electrical connection of the switch 10 many times over.

The wire connecting element 26 is preferably completely encased in insulating material in order to shield it from the switching mechanism 12 and to insulate it electrically. In the exemplary embodiment example shown here, the wire connecting element 26 is integrated into the insulating material carrier 22 and is thus spatially separated from the switching mechanism 12.

The switching mechanism 12 comprises a temperature-dependent switching element 28, a spring element 30 and a connecting component 32. In the present case, the temperature-dependent switching element 28 is a bimetallic element which has the shape of an elongated spring tongue. The spring element 30 is made of metal and is also designed as an elongated spring tongue. The connecting component 32 is designed as a plate-shaped metal sheet, the material thickness of which is preferably greater than the material thickness of the switching element 28 and greater than the material thickness of the spring element 30.

The spring element 30, the connecting component 32 and the switching element 28, which is designed as a bimetallic element, are electrically and mechanically connected in series. The spring element 30 and the switching element 28 are connected to each other only indirectly via the connecting component, but not directly. The connecting component 32 is arranged as an intermediate layer between the spring element 30 and the switching element 28 and is attached separately to the spring element 30 and the switching element 28 respectively.

A first end 34 of the spring element 30 is attached to the first electrode 18 in a firmly bonded manner. Starting from this first end 34, the spring element 30 protrudes in the manner of a cantilever beam into a cavity that is formed inside the switch 10. The opposite, second, free end 36 of the spring element 30 is attached to a first side 38 of the connecting component 32 in a firmly bonded manner (for example by soldering or welding). A second side 40 of the connecting component 32, the second side being opposite the first side 38, is attached to a first end 42 of the switching element 28 in a firmly bonded manner (for example by soldering or welding).

At a second end 44 that is opposite the first end 42, the switching element 28 carries a movable contact part 46, which co-operates with a stationary contact part 48 that is arranged on the second electrode 20.

In the closed position of the switching mechanism 12, the movable contact part 46 is pressed against the stationary contact part 48 by the spring element 30 and the switching element 28, as a result of which the switch 10 is closed and the electrically conductive connection between the two external terminals 14, 16 is established. If the temperature of the switching element 28 increases as a result of an increased current flow through the switch 10 or as a result of an increased external temperature, the creep phase of the switching element 28 begins, in which its spring force that is working against the force of the spring element 30 decreases, so that the connecting component 32 moves downwards relative to the position shown in FIG. 1. However, the mechanical series connection of the spring element 30, mechanical connecting component 32 and switching element 28 continues to press the movable contact part 44 against the stationary contact part 48. If the temperature of the switching element 28 then increases further up to or above the response temperature of the switching element 28, the switching element 28 snaps over into its high-temperature configuration shown in FIG. 2, wherein the switching mechanism 12 is brought into its open position and the electrically conductive connection between the two external terminals 14, 16 is interrupted.

At least one recess 49 is also provided in the insulating material carrier 22, through which the second electrode 20 is accessible from the outside. On the one hand, this improves the thermal connection of the switch 10 and, on the other hand, enables automated functional testing of the switch 10.

FIG. 4 shows a schematic top view of a part of an assembly belt to illustrate a method for the automated manufacture of the temperature-dependent switch 10. In particular, a conveyor belt 50 is shown, which in the case shown here comprises a plurality of holes 52 which serve to drive the conveyor belt 50 in the direction of arrow 54. However, it is understood that, depending on the type of conveyor belt drive, these holes 52 can also be dispensed with or these holes 52 can be replaced by other types of engagement elements on which the conveyor belt drive can engage.

The conveyor belt 50 is made of sheet metal and is integrally connected to a plurality of prefabricated connecting components 32, wherein FIG. 4 shows only one of this plurality of connecting components 32. The connecting component 32 is therefore part of the conveyor belt 50 and serves as a carrier material for attaching the other components of the switching mechanism 12 of the switch 10 during the manufacture of the switching mechanism 12.

In a first step, a spring element 30 and a temperature-dependent switching element are attached to each of the plurality of connecting components 32 in such a way that the spring element 30 is electrically and mechanically connected in series to the temperature-dependent switching element 28. As already mentioned, the spring element 30 is attached to the first side 38 of the connecting component 32 by means of a first firmly bonded connection. The temperature-dependent switching element 28 is attached to the opposite second side 40 of the connecting component 32 by means of a second firmly bonded connection. Preferably, the movable contact part 48 has already been attached to the switching element 28 in advance.

As soon as the switching mechanism assembly, which comprises the switching element 28, the spring element 30 and the connecting component 32, is fully assembled, the switching mechanism assembly can be separated from the conveyor belt 50 by separating the connecting component 32 along the dashed separation line 56. In this way, a switching mechanism assembly can be produced in an automated manner as a semi-finished product, which can be stored as bulk material, for example.

The switching mechanism assembly that is manufactured in this way can be connected to a first and a second external terminal 14, 16 to form the temperature-dependent switching mechanism 12 and inserted either as a whole or individually into an insulating material carrier 22, as shown in FIGS. 1 and 2.

It will be understood that if the switch is manufactured automatically, the above mentioned steps are repeated for each additional connecting component 32 that is connected to the conveyor belt 50 so as to produce additional switches 10.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A temperature-dependent switch, having a first external terminal, a second external terminal and a temperature-dependent switching mechanism,
wherein the temperature-dependent switching mechanism comprises a temperature-dependent switching element which is configured to change its geometric shape as a function of its temperature in order to switch the switching mechanism between a closed position, in which the switching mechanism establishes an electrically conductive connection between the first external terminal and the second external terminal, and an open position, in which the switching mechanism disconnects the electrically conductive connection, and
wherein the temperature-dependent switching mechanism comprises a spring element which is permanently electrically and mechanically connected in series to the temperature-dependent switching element, and
wherein the temperature-dependent switching mechanism comprises a connecting component which is arranged between the spring element and the temperature-dependent switching element and is attached to the spring element and the temperature-dependent switching element.

2. The temperature-dependent switch according to claim 1, wherein the connecting component is plate-shaped.

3. The temperature-dependent switch according to claim 1, wherein a first side of the connecting component is attached to the spring element by a first firmly bonded connection and a second side of the connecting component is attached to the temperature-dependent switching element by a second firmly bonded connection.

4. The temperature-dependent switch according to claim 1, wherein the connecting component is thicker than the spring element and the temperature-dependent switching element.

5. The temperature-dependent switch according to claim 1, wherein the spring element and the connecting component each comprise metal.

6. The temperature-dependent switch according to claim 1, wherein the temperature-dependent switching element comprises a bimetal or trimetal.

7. The temperature-dependent switch according to claim 1, wherein the spring element and the temperature-dependent switching element are connected to each other only indirectly via the connecting component.

8. The temperature-dependent switch according to claim 1, wherein a first end of the spring element is attached to a first electrode that is electrically connected to the first external terminal, and wherein a second end of the spring element is attached to the connecting component.

9. The temperature-dependent switch according to claim 1, wherein a first end of the temperature-dependent switching element is attached to the connecting component, wherein a second end of the temperature-dependent switching element carries a movable contact part which, in the closed position of the temperature-dependent switching mechanism, is pressed against a stationary contact part by the spring element and the temperature-dependent switching element, the stationary contact part being arranged on a second electrode that is electrically connected to the second external terminal, and wherein the temperature-dependent switching element is configured to change its geometric shape as a function of its temperature in such a way that it lifts the movable contact part away from the stationary contact part in the open position of the switching mechanism in order to disconnect the electrically conductive connection.

10. The temperature-dependent switch according to claim 1, wherein a first end of the spring element is attached to a first electrode that is electrically connected to the first external terminal, wherein a second end of the spring element is attached to the connecting component, wherein a first end of the temperature-dependent switching element is attached to the connecting component, wherein a second end of the temperature-dependent switching element carries a movable contact part which, in the closed position of the temperature-dependent switching mechanism, is pressed against a stationary contact part by the spring element and the temperature-dependent switching element, the stationary contact part being arranged on a second electrode that is electrically connected to the second external terminal, and wherein the temperature-dependent switching element is configured to change its geometric shape as a function of its temperature in such a way that it lifts the movable contact part away from the stationary contact part in the open position of the switching mechanism in order to disconnect the electrically conductive connection.

11. The temperature-dependent switch according to claim 10, wherein the first end of the spring element and the second end of the temperature-dependent switching element are arranged on a same side with respect to the connecting element.

12. The temperature-dependent switch according to claim 10, wherein the first electrode and the second electrode are held at a distance from one another by an insulating material carrier, and wherein the temperature-dependent switching mechanism is arranged in a recess of the insulating material carrier between the first and the second electrode.

13. The temperature-dependent switch according to claim 12, wherein the first electrode is shaped in the form of a cover or plate or disc and is surrounded along its entire circumference by the insulating material carrier.

14. The temperature-dependent switch according to claim 10, wherein the first external terminal and the second external terminal are arranged parallel to one another in a common plane, and wherein the first external terminal is electrically connected to the first electrode via a wire connecting element that is aligned transversely to the first and second electrodes.

15. The temperature-dependent switch according to claim 14, wherein the wire connecting element is at least partially encased by or embedded in an insulating material.

16. A method of manufacturing a temperature-dependent switch, comprising the steps of:
(i) providing a conveyor belt to which a plurality of connecting components made of sheet metal are integrally connected;
(ii) attaching a spring element and a temperature-dependent switching element to one of the plurality of connecting components such that the spring element is electrically and mechanically connected in series to the temperature-dependent switching element;
(iii) separating the one connecting component from the conveyor belt to form a switching mechanism assembly that comprises the one connecting component to which the spring element and the temperature-dependent switching element are attached;
(iv) connecting the switching mechanism assembly to a first external terminal and a second external terminal to form a temperature-dependent switch with a temperature-dependent switching mechanism, in which the temperature-dependent switching element is configured to change its geometric shape as a function of its temperature, in order to switch the switching mechanism between a closed position, in which the switching mechanism establishes an electrically conductive connection between the first external terminal and the second external terminal, and an open position, in which the switching mechanism disconnects the electrically conductive connection; and
(v) repeating steps (ii)-(iv) for more of the plurality of connecting components.
